(19) United States
(12) Patent Application Publication
(10) Pub. No.: US 2024/0326804 A1
(43) Pub. Date: Oct. 3, 2024

(54) VEHICLE CONTROL DEVICE AND VEHICLE CONTROL METHOD THEREOF

(71) Applicant: Honda Motor Co., Ltd., Tokyo (JP)

(72) Inventor: Shogo NISHIZAWA, Tokyo (JP)

(73) Assignee: Honda Motor Co., Ltd., Tokyo (JP)

(21) Appl. No.: 18/413,055

(22) Filed: Jan. 16, 2024

(30) Foreign Application Priority Data
Mar. 28, 2023 (CN) 202310311067.6

(51) Int. Cl. B60W 30/14; B60W 30/18; B60W 60/00

(52) U.S. Cl. CPC B60W 30/146; B60W 30/18172; B60W 60/001; B60W 2520/263; B60W 2520/28

(57) ABSTRACT

A vehicle control device and a vehicle control method thereof are provided in the disclosure. The judgment unit determines a possibility of executing the idle suppression control based on a driving state of the vehicle. The driving force control unit executes driving force control on the vehicle according to external conditions of the vehicle. During execution of the driving force control, when the judgment unit determines that there is the possibility of executing the idle suppression control, the driving force control unit is controlled to increase a driving force distribution ratio of a driven wheel and decrease a driving force distribution ratio of a driving wheel while maintaining a state of an overall driving force of the vehicle.

### CROSS-REFERENCE TO RELATED APPLICATION

This application claims the priority benefit of China application serial no. 202310311067.6 filed on Mar. 28, 2023. The entirety of the above-mentioned patent application is hereby incorporated by reference herein and made a part of this specification.

### BACKGROUND

### Technical Field

The disclosure relates to a control device, and in particular relates to a vehicle control device and a vehicle control method thereof.

### Description of Related Art

In recent years, efforts have been made to provide a friendly and sustainable transportation system for the disadvantaged participants in transportation. For example, how to further improve traffic safety and convenience through the use of driving assistance technology is one significant direction of effort.

Traditionally, when driving with autonomous driving (AD) or advanced driving assistance systems (ADAS), the vehicle control device automatically calculates the driving force required to keep the vehicle traveling at the set speed and allocates the driving force to the vehicle.

However, for electric vehicles such as rear-wheel drive or four-wheel drive vehicles where the rear wheels are driven by a motor, when too much driving force is allocated to the rear wheels, the traction control system (TCS) will intervene in vehicle control.

If the traction control system intervenes in vehicle control while the driver is not operating the autonomous driving or advanced driving assistance systems of the vehicle, it may cause discomfort or uneasiness to the driver. For example, if too much driving force is allocated to the rear wheels during the turning process, the vehicle may become unstable (the wheels may spin idly).

For another example, general electric vehicles may use regenerative braking to improve their cruising range. The drive torque produced instantaneously by the rear wheel motor, transitioning from regenerative braking (deceleration state/negative acceleration) to driving force generation (acceleration state), may result in excessive driving force from the rear wheel motor. This could increase the frequency of the intervention of the traction control system in vehicle control.

### SUMMARY

A vehicle control device and a vehicle control method thereof, which may effectively reduce the intervention of the traction control system, maintain the overall driving force of the vehicle, prevent unnecessary deceleration, and enhance the stability of the vehicle, thereby providing a sustainable transportation system that may improve traffic safety and convenience, are provided in the disclosure.

The vehicle control device of the disclosure includes a driving force adjustment device, configured to adjust the driving force of a vehicle and execute idle suppression control. The driving force adjustment device includes a judgment unit and a driving force control unit. The judgment unit determines a possibility of executing the idle suppression control based on a driving state of the vehicle. The driving force control unit executes driving force control on the vehicle according to external conditions of the vehicle. During execution of the driving force control, when the judgment unit determines that there is the possibility of executing the idle suppression control, the driving force control unit is controlled to increase a driving force distribution ratio of a driven wheel and decrease a driving force distribution ratio of a driving wheel while maintaining a state of an overall driving force of the vehicle.

A vehicle control method of a vehicle control device is also provided in the disclosure, in which the following operation is included. Driving force control of a vehicle is executed according to external conditions of the vehicle. A possibility of executing idle suppression control is determined based on a driving state of the vehicle. During execution of the driving force control, when it is determined that there is the possibility of executing the idle suppression control, a driving force distribution ratio of a driven wheel is increased and a driving force distribution ratio of a driving wheel is decreased while maintaining a state of an overall driving force of the vehicle.

Based on the above, in the embodiment of the disclosure, when it is determined that there is the possibility of executing the idle suppression control, a driving force distribution ratio of a driven wheel is increased and a driving force distribution ratio of a driving wheel is decreased while maintaining a state of an overall driving force of the vehicle. This may effectively reduce the intervention of the traction control system, maintain the overall driving force of the vehicle, prevent unnecessary deceleration, and enhance the stability of the vehicle when using autonomous driving or advanced driving assistance systems, thereby providing a sustainable transportation system that may improve traffic safety and convenience, are provided in the disclosure.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a vehicle control device and a motor device according to an embodiment of the disclosure.

FIG. 2 is a schematic diagram of the slip rate of a wheel according to an embodiment of the disclosure.

FIG. 3 is a schematic diagram of adjusting the driving force distribution ratio according to an embodiment of the disclosure.

FIG. 4 is a flowchart of a vehicle control method of a vehicle control device according to an embodiment of the disclosure.

### DETAILED DESCRIPTION OF DISCLOSED EMBODIMENTS

In order to make the content of the disclosure easier to understand, the following specific embodiments are illustrated as examples of the actual implementation of the disclosure. In addition, wherever possible, elements/components with the same reference numerals in the drawings and embodiments represent the same or similar parts.

In one embodiment of the disclosure, while the driving force control unit is executing the driving force control and after a preset time has elapsed since an adjustment of the driving force distribution ratio of the driven wheel and the driving wheel is completed, the judgment unit re-determines the possibility of executing the idle suppression control. When the judgment unit re-determines the possibility of executing the idle suppression control, the driving force control unit reduces a set vehicle speed of the vehicle.

In an embodiment of the disclosure, when the judgment unit re-determines not to execute the idle suppression control, the driving force control unit restores the reduced set vehicle speed to the set vehicle speed prior to reduction.

In an embodiment of the disclosure, after the driving force control unit restores the reduced set vehicle speed to the set vehicle speed prior to reduction, the driving force control unit restores the adjusted driving force distribution ratio of the driven wheel and the driving wheel to the driving force distribution ratio of the driven wheel and the driving wheel prior to adjustment.

In an embodiment of the disclosure, the driven wheel is a front wheel, and the driving wheel is a rear wheel.

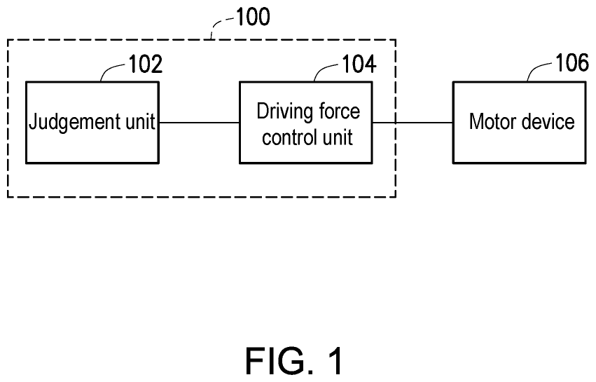

FIG. 1 is a schematic diagram of a vehicle control device and a motor device according to an embodiment of the disclosure, please refer to FIG. 1. The vehicle control device 100 includes a driving force adjustment device that may adjust the driving force of the vehicle, execute idle suppression control (e.g., activating a traction control system to intervene in vehicle control), and suppress wheel idle spin. The driving force adjustment device may include a judgment unit 102 and a driving force control unit 104. The driving force control unit 104 couples the determination unit 102 and the electric motor device 106 of the vehicle. The judgment unit 102 and the driving force control unit 104 may be implemented by, for example, a processor, an electronic control unit (ECU) or a microcontroller (MCU), but are not limited thereto. The determination unit 102 may determine the possibility of executing the idle suppression control based on the driving state of the vehicle, for example, it may determine whether to execute the idle suppression control based on the wheel speed difference of the driving wheel of the vehicle, but not limited thereto. The driving force control unit 104 may execute driving force control on the vehicle according to external conditions of the vehicle. For example, when driving using autonomous driving or advanced driving assistance systems, the vehicle may have different wheel slip rates corresponding to different road conditions. The driving force control unit 104 may control the driving force output by the motor device 106 according to the wheel slip rate of the driving wheel, so that the motor device 106 may provide a suitable driving force to the driving wheel.

During the execution of the driving force control, when the judgment unit 102 determines that there is a possibility of executing the idle suppression control, for example, when the number of times the slip rate of the wheel is greater than the preset slip rate for a first preset number of times, a driving force distribution ratio of a driven wheel is increased and a driving force distribution ratio of a driving wheel is decreased while maintaining the state of an overall driving force of the vehicle, in order to avoid the intervention of the traction control system, prevent unnecessary deceleration and enhance the stability of the vehicle while maintaining the overall driving force of the vehicle.

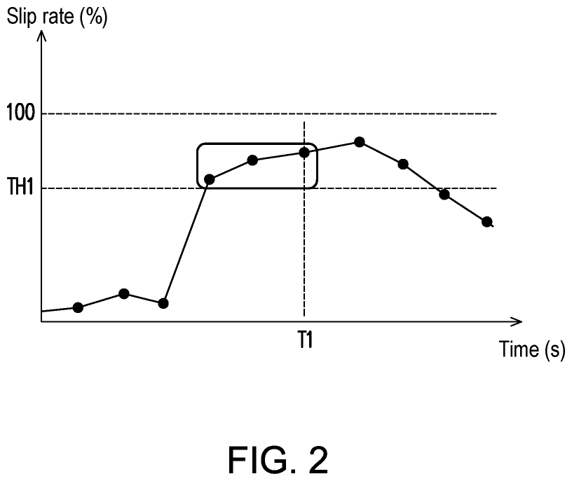

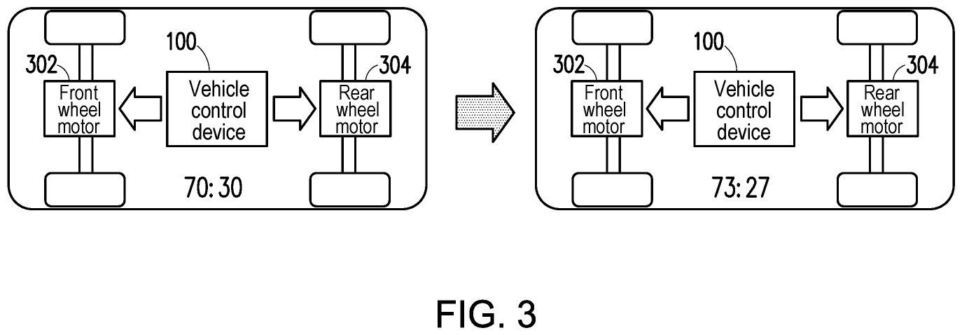

For example, when the driving wheel is the rear wheel and the driven wheel is the front wheel, the judgment unit 102 may calculate the slip rate of the wheel based on the wheel speed difference between the left rear wheel and the right rear wheel. For example, the greater the wheel speed difference between the left rear wheel and the right rear wheel, the higher the slip rate of the wheel, and the higher the possibility of requiring the execution of idle suppression control. The judgment unit 102 may calculate the slip rate of the wheel corresponding to different wheel speed differences. When the slip rate of the wheel exceeds the preset slip rate for a first preset number of times, the driving force control unit 104 is controlled to increase the driving force distribution ratio of the driven wheel and reduce the driving force distribution ratio of the driving wheel. For example, as shown in the embodiment of FIG. 2 and FIG. 3, in the embodiment of FIG. 2, when the judgment unit 102 determines that the slip rate of the wheel is greater than the preset slip rate TH1 for three times at the time point T1, the judgment unit 102 may control the driving force control unit 104 to increase the driving force distribution ratio of the driven wheel and to decrease the driving force distribution ratio of the driving wheel. When the slip rate of the wheel reaches 100%, the traction control system is activated to intervene in vehicle control.

It is worth noting that in some embodiments, the driving wheel and the driven wheel may also respectively be the front wheel and the rear wheel, and are not limited to the driving wheel being the rear wheel and the driven wheel being the front wheel. In other embodiments, the vehicle may also be four-wheel drive. For example, as shown in the embodiment of FIG. 3, the vehicle is equipped with motor devices on both the front wheels and the rear wheels, in which the front wheels and the rear wheels are respectively equipped with a front wheel motor 302 and a rear wheel motor 304. In the embodiment of FIG. 3, the driving wheels are rear wheels and the driven wheels are front wheels. When the judgment unit 102 determines that the slip rate of the wheel is greater than the preset slip rate, the judgment unit 102 may control the driving force control unit 104 to adjust the driving force distribution ratio of the front wheel motor 302 and the rear wheel motor 304 from 70:30 to 73:27, that is, increasing the driving force distribution ratio of the front wheels and reducing the driving force distribution ratio of the rear wheels.

In some embodiments, the vehicle requirements for the four-wheel drive mode may include that the driving force distribution ratio of each wheel is required to be greater than a preset threshold, so the driving force control unit 104 may only reduce the driving wheels to the preset threshold. For example, when the preset threshold is 20%, the driving force control unit 104 may only adjust the driving force distribution ratio of the front wheel motor 302 and the rear wheel motor 304 to 80:20. In the case where the driving force control unit 104 reduces the driving wheels to the preset threshold, if the judgment unit 102 still determines that the slip rate of the wheel is greater than the preset slip rate TH1, the judgment unit 102 may reduce the set vehicle speed of the vehicle when using autonomous driving or advanced driving assistance systems. For example, the driving force control unit 104 is controlled to reduce the overall driving force of the vehicle so that the vehicle travels at a reduced set vehicle speed (at this time, the driving force distribution ratio of the front wheels and the rear wheels is still maintained at the adjusted 80:20).

In some embodiments, the judgment unit 102 may also reduce the set vehicle speed of the vehicle when it is repeatedly determined that there is a possibility of executing idle suppression control. For example, when the number of times it is repeatedly determined that the slip rate of the wheel is greater than the preset slip rate TH1 are a second preset number of times, the set vehicle speed of the vehicle is reduced without waiting for the driving force distribution ratio of the driving wheels to be reduced to the preset threshold. For example, after the first preset time has elapsed since the N^{th} adjustment of the driving force distribution ratio of the driving wheel and the driven wheel is completed, the judgment unit 102 may re-determine the possibility of executing the idle suppression control, where N is a positive integer. When the judgment unit re-determines that the slip rate of the wheel is greater than the preset slip rate for the second preset number of times, the judgment unit 102 controls the driving force control unit 104 to reduce the set vehicle speed of the vehicle.

After lowering the set vehicle speed of the vehicle, for example, after the second preset time has elapsed since lowering the set vehicle speed of the vehicle, the judgment unit 102 may continue to re-determine the possibility of executing the idle suppression control. When the judgment unit 102 re-determines not to execute the idle suppression control, the driving force control unit 104 restores the reduced set vehicle speed to the set vehicle speed prior to reduction. For example, when the judgment unit 102 re-determines that the slip rate of the wheel is not greater than the preset slip rate TH1 for the third preset number of times, it means that the driving state of the vehicle is stable, and the judgment unit 102 may control the driving force control unit 104 to restore the set vehicle speed of the vehicle to the set vehicle speed prior to adjustment (at this time, the driving force distribution ratio of the front wheels and the rear wheels is still the adjusted 80:20).

After restoring the set vehicle speed of the vehicle, the driving force control unit 104 may restore the adjusted driving force distribution ratio of the driven wheel and the driving wheel to the driving force distribution ratio of the driven wheel and the driving wheel prior to adjustment. For example, after the third preset time has elapsed since the set vehicle speed of the vehicle is reduced, the judgment unit 102 may continue to re-determine the possibility of executing the idle suppression control. When the judgment unit 102 re-determines that the slip rate of the wheel is not greater than the preset slip rate TH1 for the fourth preset number of times, the judgment unit 102 may control the driving force control unit 104 to restore the driving force distribution ratio of the driving wheel and the driven wheel to the driving force distribution ratio prior to adjustment.

In this way, the vehicle may reach its destination comfortably and safely at the set vehicle speed while ensuring the stability of the vehicle.

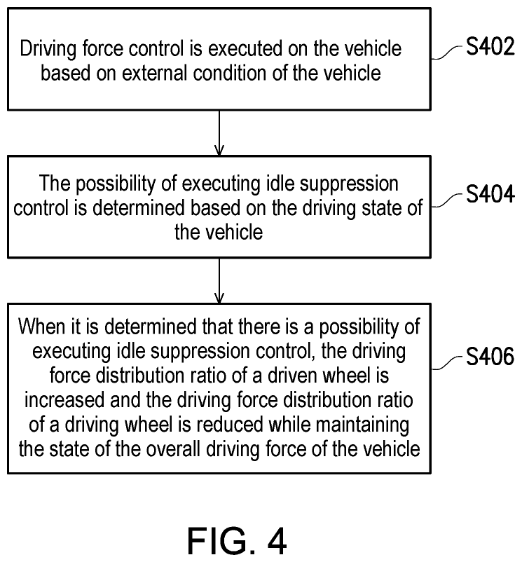

FIG. 4 is a flowchart of a vehicle control method of a vehicle control device according to an embodiment of the disclosure, in which the vehicle uses autonomous driving or advanced driving assistance systems to travel at a set vehicle speed. As may be seen from the above embodiments, the vehicle control method of the vehicle control device may include, for example, the following steps. Firstly, driving force control of a vehicle is executed according to external conditions of the vehicle (step S402). Next, a possibility of executing idle suppression control is determined based on a driving state of the vehicle (step S404). Then, during execution of the driving force control, when it is determined that there is the possibility of executing the idle suppression control, a driving force distribution ratio of a driven wheel is increased and a driving force distribution ratio of a driving wheel is decreased while maintaining a state of an overall driving force of the vehicle (step S406), in which the driven wheel may be, for example, the front wheel, and the driving wheel may be, for example, the rear wheel, but not limited thereto.

To sum up, in the embodiment of the disclosure, when it is determined that there is the possibility of executing the idle suppression control, a driving force distribution ratio of a driven wheel is increased and a driving force distribution ratio of a driving wheel is decreased while maintaining a state of an overall driving force of the vehicle. This may effectively reduce the intervention of the traction control system, maintain the overall driving force of the vehicle, prevent unnecessary deceleration, and enhance the stability of the vehicle when using autonomous driving or advanced driving assistance systems, thereby providing a sustainable transportation system that may improve traffic safety and convenience, are provided in the disclosure.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the claims.

What is claimed is:

1. A vehicle control device, comprising:
a driving force adjustment device, adjusting driving force of a vehicle and executing idle suppression control, the driving force adjustment device comprising:
a judgment unit, determining a possibility of executing the idle suppression control based on a driving state of the vehicle; and
a driving force control unit, executing driving force control on the vehicle according to external conditions of the vehicle, wherein during execution of the driving force control, when the judgment unit determines that there is the possibility of executing the idle suppression control, the driving force control unit is controlled to increase a driving force distribution ratio of a driven wheel and decrease a driving force distribution ratio of a driving wheel while maintaining a state of an overall driving force of the vehicle.

2. The vehicle control device according to claim 1, wherein the vehicle uses autonomous driving or advanced driver assistance systems to travel at a set vehicle speed, while the driving force control unit is executing the driving force control and after a preset time has elapsed since an adjustment of the driving force distribution ratio of the driven wheel and the driving wheel is completed, the judgment unit re-determines the possibility of executing the idle suppression control, when the judgment unit re-determines the possibility of executing the idle suppression control, the driving force control unit reduces the set vehicle speed of the vehicle.

3. The vehicle control device according to claim 2, wherein when the judgment unit re-determines not to execute the idle suppression control, the driving force control unit restores the reduced set vehicle speed to the set vehicle speed prior to reduction.

4. The vehicle control device according to claim 3, wherein after the driving force control unit restores the reduced set vehicle speed to the set vehicle speed prior to reduction, the driving force control unit restores the adjusted driving force distribution ratio of the driven wheel and the driving wheel to the driving force distribution ratio of the driven wheel and the driving wheel prior to adjustment.

5. The vehicle control device according to claim 1, wherein the driven wheel is a front wheel, and the driving wheel is a rear wheel.

6. A vehicle control method of a vehicle control device, comprising:
executing driving force control of a vehicle according to external conditions of the vehicle;
determining a possibility of executing idle suppression control based on a driving state of the vehicle;
increasing a driving force distribution ratio of a driven wheel and decreasing a driving force distribution ratio of a driving wheel while maintaining a state of an overall driving force of the vehicle when it is determined that there is the possibility of executing the idle suppression control and during execution of the driving force control.
